(19) United States
(12) Patent Application Publication
(10) Pub. No.: US 2010/0315515 A1
(43) Pub. Date: Dec. 16, 2010

(54) COMMUNICATION NETWORK CAMERA

(76) Inventors: Kuo-Liang Chen, Hsinchu City (TW); Hsiang-Chiao Chen, Hsinchu City (TW); Yu-An Chen, Hsinchu City (TW); Yu-Ming Chen, Hsinchu City (TW)

Correspondence Address: Kuo-Liang Chen, 235 Chung - Ho, Box 8-24, Taipei, 235, TW

(21) Appl. No.: 12/485,061

(22) Filed: Jun. 16, 2009

(51) Int. Cl. H04N 5/225

(52) U.S. Cl. 348/207.1; 348/E05.024

(57) ABSTRACT

A communication network camera comprise a front cover, a rear cover, a camera device, and a control device; the camera device and the control device being installed between the front cover and the rear cover; the front cover and the rear cover serving for protecting the camera device and the control device; the front cover being installed with a protection cover for protecting a camera lens and an infrared LED lamp of the camera device; the rear cover being formed with an SIM card insertion end, a power insertion end, a network insertion end, and an antenna for image and message transmission in 3G communication; wherein by using a 3G Modem to search and find an IP from a communication company which is shared by any people for image and message transformation without using ADSL to find the IP; the camera further comprise a battery for carrying out.

### FIELD OF THE INVENTION

The present invention relates to a communication network camera, wherein by using a 3G Modem to search and find an IP from a communication company which is shared by any people for image and message transformation without using ADSL to find the IP; the camera further comprise a battery for carrying out.

### BACKGROUND OF THE INVENTION

With the population of network, networks are widely used all over the world, and have become a part of human life. This is because the networks can increase the communications of humans, transformation of information, such as arts, music, amusements, educations, cultures transformation, etc., people can search information through networks, interchange experiences, and learn new knowledge, download music and movies, etc. from network. Moreover, network can increase business actions, such as network bookstores has occupied a great weight in book business. Since more and more people connect to networks, the network business has becomes a great part in business.

Textures, images, moves can be transferred through networks. To widen the use of information transformation through networks, network cameras are developed for capture images. However transformation of network images need the use of wideband network, such as ADSL, however the place without ADSL can not perform network image transformation.

From above discussion, it is known that the prior art network cameras are not sufficient for use in daily life and a novel design is necessary for improving the prior art defects. L

### SUMMARY OF THE INVENTION

The object of the present invention is to use a 3G Modem to search and find the IP (Internet protocol) which are shared to all people. Then a camera device serves to obtain images and messages. The camera device is unnecessary to search the IP through ADSL.

To achieve above objects, the present invention comprises the following elements:

A front cover for protection a camera device and a control device therein; and the front cover has a protection cover to protect the camera lens of the camera device and an infrared LED lamp;

A rear cover serves for protecting the camera device and the control device therein and the rear cover is installed with an SIM card insertion end, a power insertion end, a network insertion end, and an antenna. After actuation, an SIM card and the 3G Modem will search and find IP of the communication company and an antenna serves to receive and transfer images and messages after the IP is assured.

A camera device has a camera lens and an infrared LED lamp. The image and messages captured by the camera lens of the camera device will be temporarily stored in an integrated circuit of the control device. The infrared LED lamp serves to increase the light source as without illumination or in dark area so as to have a better effect.

A control device is formed by at least one integrated circuit. The integrated circuit includes a central processing unit (such as a Linux CPU) and a RAM for processing the image and messages from the lens of the camera device; and control the SIM card and the 3G Modem to search and find the IP of the communication company for image and message transformation so as to complete the image capturing through a network.

The operation of the communication network camera according to the present invention is illustrated. It is illustrated that an SIM card is firstly placed in the SIM card insertion end at the rear cover of the communication network camera. Then a transformer is inserted into the power insertion end. The transformer is connected to a public power (110 Volt or 220 Volts power source). The Linux CPU serves to process the image capture of the lens of the camera. The captured image and messages are stored in the RAM temporarily. The network line is connected to the network insertion end and another end thereof is connected to the 3G Modem. The Linux CPU serves to control the search and capturing of the IP (Internet Protocol). Finally, the antenna will receive and transfer the image and related messages after the IP is assured.

The various objects and advantages of the present invention will be more readily understood from the following detailed description when read in conjunction with the appended drawing.

### BRIEF DESCRIPTION OF THE DRAWINGS

FIG. 1 is a schematic perspective view of the communication network camera according to the present invention.

FIG. 2 is another schematic perspective view of the communication network camera according to the present invention.

FIG. 3 is an assembly schematic view about the control device of the communication network camera of the present invention.

FIG. 5 shows the operation of the communication network camera of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

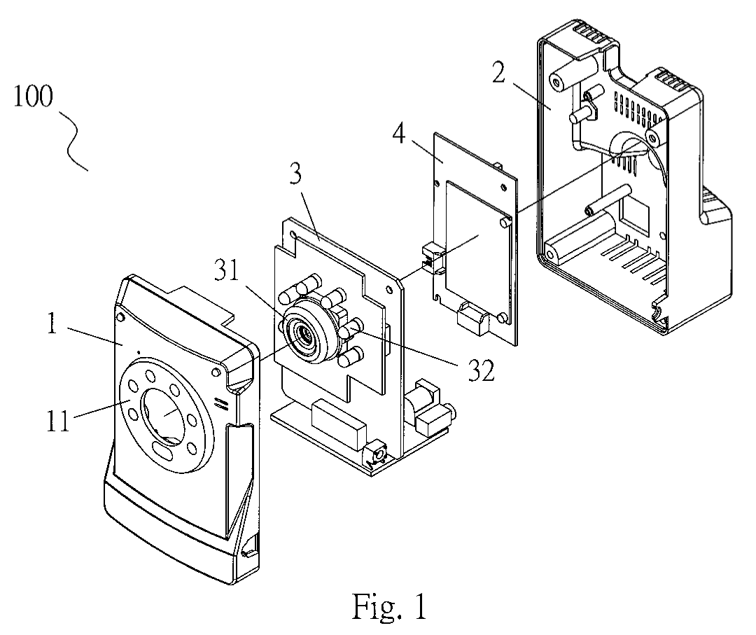

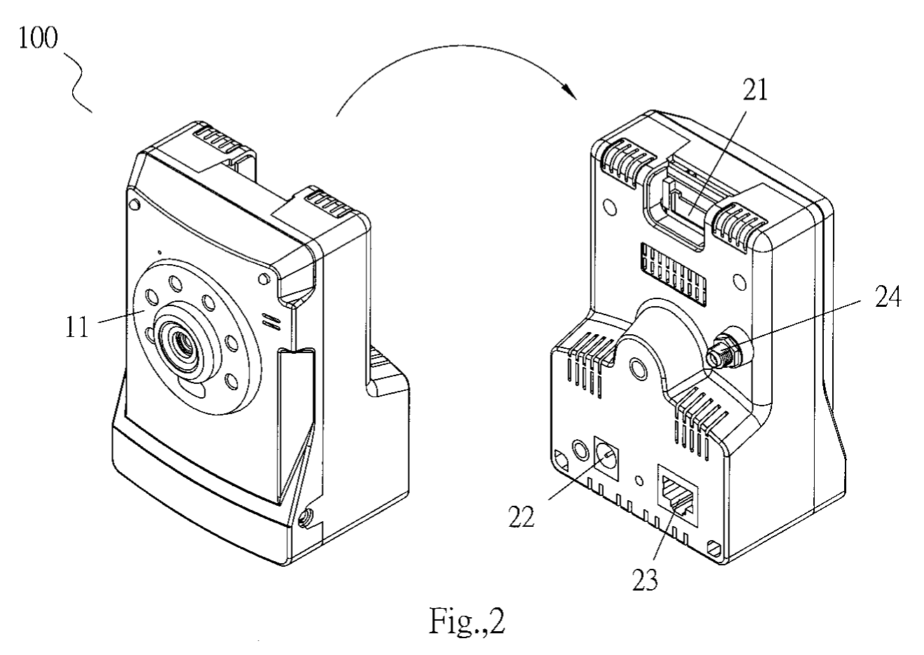

With reference to FIGS. 1 and 2, the communication network camera 100 according to the present invention is illustrated. The present invention comprises a front cover 1, a rear cover 2, a camera device 3, and a control device 4. The camera device 3 and the control device 4 are installed between the front cover 1 and the rear cover 2. The front cover 1 and the rear cover 2 serve to protect the camera device 3 and the control device 4. The front cover 1 is installed with a protection cover 11 for protecting a camera lens 31 and an infrared LED lamp 32 of the camera device 3. The rear cover 2 is formed with an SIM card insertion end 21, a power insertion end 22, a network insertion end 23, and an antenna 24 for image and message transmission in 3G communication.

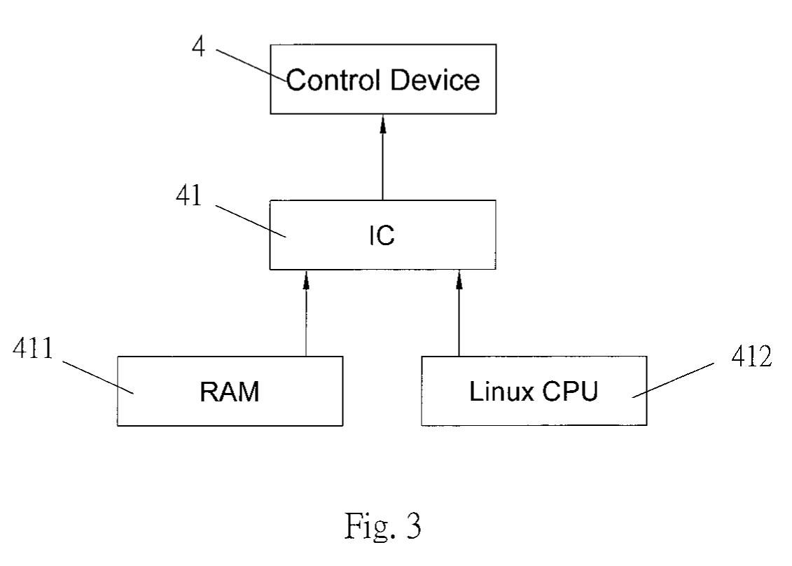

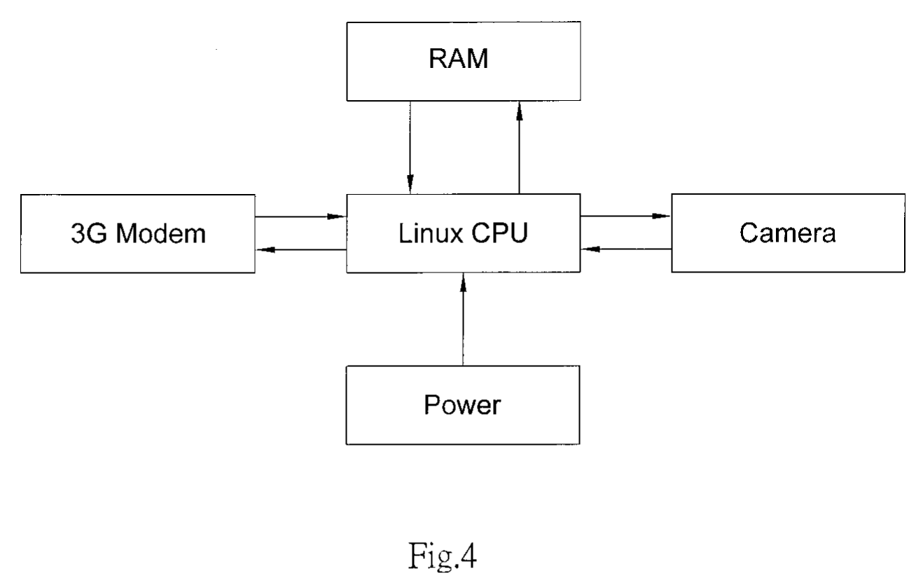

Referring to FIG. 3, a schematic view about the assembly of the control device of the communication network camera. From the drawing, it is known that the control device 4 is formed by at least one integrated circuit 41. The integrated circuit 41 includes a central processing unit 412 (a Linux CPU) and a RAM 411 for processing the image and the message from the camera lens 31 of the camera device 3 and controlling the SIM card and the 3G Modem to search and capture the image and message transmitted from an IP (Internet protocol) to complete a control action.

With reference to FIG. 4, a flow diagram about the operation process of the communication network camera of the present invention is illustrated. It is illustrated that a power source is actuated to actuate the central processing unit of the control device so that the camera lens will capture images; and the captured images and related messages are transmitted back to the central processing unit (Linux CPU). Then they are transferred to the RAM to be stored temporarily. Then the CPU will inform the 3G Modem to search and obtain the IP from a communication office. When a correct IP is searched, it is transferred to the CPU to assure the IP and receive the transferred image and messages.

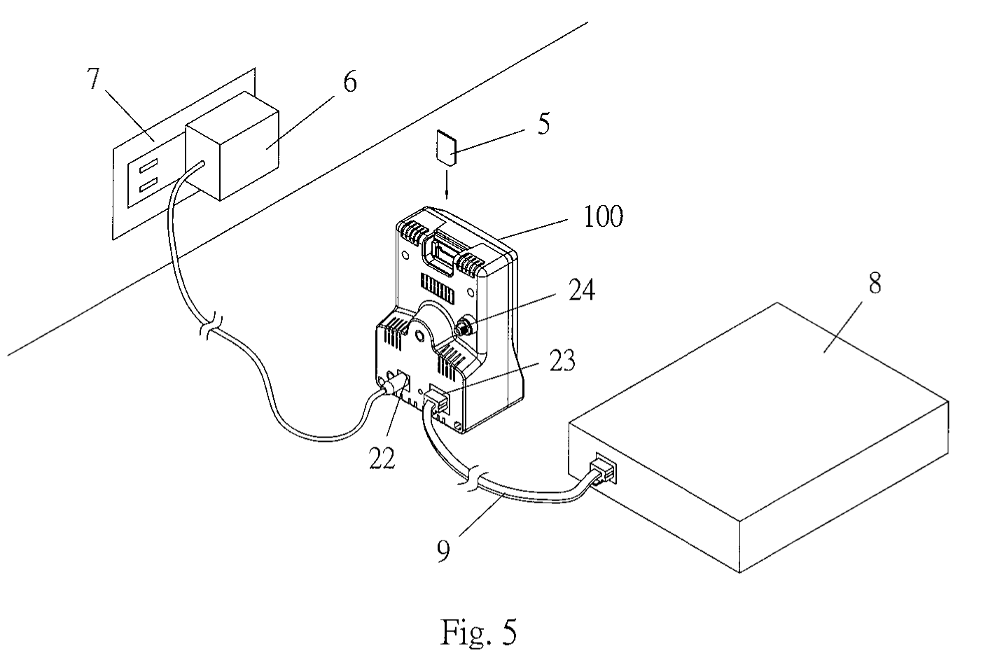

Referring to FIG. 5, the operation of the communication network camera according to the present invention is illustrated. It is illustrated that an SIM card 5 is firstly placed in the SIM card insertion end 21 at the rear cover 2 of the communication network camera 100. Then a transformer 6 is inserted into the power insertion end 22. The transformer 6 is connected to a public power 7 (110 Volt or 220 Volts power source). The Linux CPU serves to process the image capture of the lens of the camera. The captured image and messages are stored in the RAM temporarily. The network line 9 is connected to the network insertion end 23 and another end thereof is connected to the 3G Modem 8. The Linux CPU serves to control the search and capturing of the IP (Internet Protocol). Finally, the antenna will receiver and transfer the image and related messages after the IP is assured.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A communication network camera comprising a front cover, a rear cover, a camera device, and a control device; the camera device 3 and the control device being installed between the front cover and the rear cover; the front cover and the rear cover serving for protecting the camera device and the control device; the front cover being installed with a protection cover for protecting a camera lens and an infrared LED lamp of the camera device; the rear cover being formed with an SIM card insertion end, a power insertion end, a network insertion end, and an antenna for image and message transmission in 36 communication; wherein by using a 3G Modem to search and find an IP from a communication company which is shared by any people for image and message transformation without using ADSL to find the IP; the camera further comprising a battery for carrying out.

2. The communication network camera as claimed in claim 1, wherein the lens of the camera device and the infrared LED lamp installed thereon serves to increase image capturing ability in dark.

3. The communication network camera as claimed in claim 1, wherein the control device is formed by at least one integrated circuit.

4. The communication network camera as claimed in claim 3, wherein the integrated circuit includes a Linux CPU and a RAM.
